(19) United States
(12) Patent Application Publication
(10) Pub. No.: US 2026/0119478 A1
(43) Pub. Date: Apr. 30, 2026

(54) INFORMATION PROCESSING METHOD

(71) Applicant: TOYOTA JIDOSHA KABUSHIKI KAISHA, Toyota-shi (JP)

(72) Inventor: Hideki KAWAI, Tokyo-to (JP)

(73) Assignee: TOYOTA JIDOSHA KABUSHIKI KAISHA, Toyota-shi (JP)

(21) Appl. No.: 19/362,997

(22) Filed: Oct. 20, 2025

(30) Foreign Application Priority Data
Oct. 25, 2024 (JP) 2024-188610

(51) Int. Cl. G06F 16/242; G06F 16/2455

(52) U.S. Cl. CPC G06F 16/2425; G06F 16/2455

(57) ABSTRACT

A method executed by an information processing apparatus includes registering a corresponding domain keyword and target phrase for each candidate search target, obtaining a query containing the domain keyword corresponding to the search target identified from an input question, executing multiple rounds of a search process including steps of inputting the query into a search engine, identifying and counting each snippet containing the target phrase corresponding to the search target on a screen displaying search results, and adding keywords contained in one or more identified snippets to the query, obtaining an answer to the question based on the search results of a round in which a count of snippets containing the target phrase is highest in the executed multiple rounds of the search process, and outputting the obtained answer.

### CROSS-REFERENCE TO RELATED APPLICATION

This application claims priority to Japanese Patent Application No. 2024-188610, filed on Oct. 25, 2024, the entire contents of which are incorporated herein by reference.

### TECHNICAL FIELD

The present disclosure relates to an information processing method.

### BACKGROUND

Conventionally, technology related to dialogue systems that provide answers to user questions is known. For example, Patent Literature (PTL) 1 discloses technology for generating a dialogue bot specialized for a given domain using a large language model based on documents of that domain.

### CITATION LIST

### Patent Literature

PTL 1: JP 2023-076413 A

### SUMMARY

The literature discloses technology for generating a dialogue bot by constructing a large language model using machine learning methods such as autoregressive models. However, there is room for improvement in the selection of queries input to the search engine to output appropriate answers in dialogue systems.

It would be helpful to improve technology for selecting queries used to output appropriate answers.

A method executed by an information processing apparatus according to an embodiment of the present disclosure includes:
registering a corresponding domain keyword and target phrase for each candidate search target;
obtaining a query containing the domain keyword corresponding to the search target identified from an input question;
executing multiple rounds of a search process including steps of:
   inputting the query into a search engine;
   identifying and counting each snippet containing the target phrase corresponding to the search target on a screen displaying search results; and
   adding keywords contained in one or more identified snippets to the query;
obtaining an answer to the question based on the search results of a round in which a count of snippets containing the target phrase is highest in the executed multiple rounds of the search process; and
outputting the obtained answer.

According to an embodiment of the present disclosure, technology for selecting queries used to output appropriate answers is improved.

### BRIEF DESCRIPTION OF THE DRAWINGS

In the accompanying drawings:

FIG. 1 is a block diagram illustrating a schematic configuration of a system according to an embodiment of the present disclosure; and

FIG. 2 is a flowchart illustrating operations of an information processing apparatus.

### DETAILED DESCRIPTION

Hereinafter, an embodiment of the present disclosure will be described.

### (Outline of Embodiment)

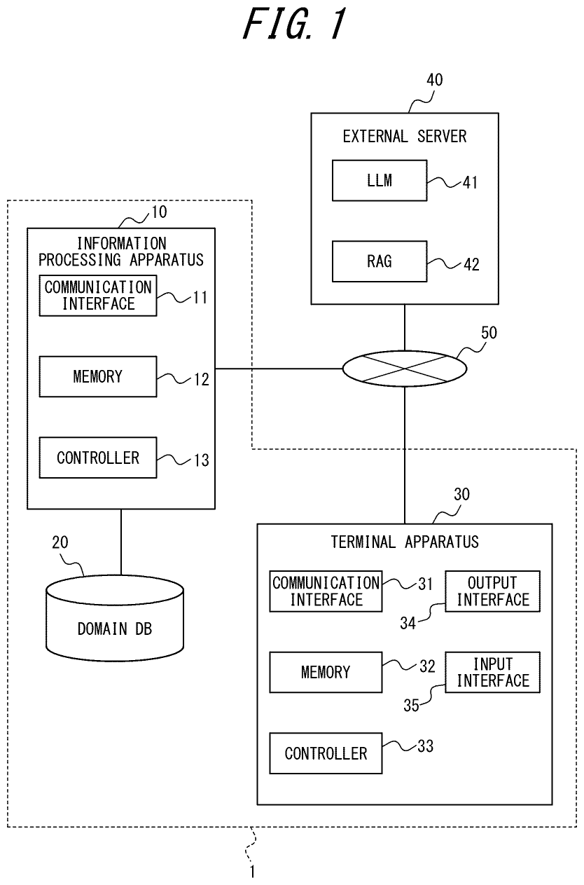

An outline of a system 1 according to the embodiment of the present disclosure will be described with reference to FIG. 1. The system 1 includes an information processing apparatus 10, a domain database (domain DB) 20, and a terminal apparatus 30. The system 1 is communicably connected to an external server 40 via a network 50 including, for example, the Internet and a mobile communication network. The system 1 constructs a dialogue system that outputs answers to questions such as “Please tell me the appraisal amount for used cars” from operators such as automobile sales businesses.

The information processing apparatus 10 is, for example, a computer such as a server apparatus. The domain DB 20 is a database that stores information related to input and output to the search engine for each search target. The domain DB 20 may be provided on a computer such as a server installed in a cloud environment or an on-premises environment, or may be provided on the information processing apparatus 10. The terminal apparatus 30 may be a mobile device such as a smartphone, mobile phone, wearable device, or tablet, a navigation device mounted in a vehicle, or general purpose or dedicated devices such as a PC (personal computer), but is not limited to these.

Furthermore, the external server 40 illustrated in FIG. 1 is a server of an entity that provides an LLM (large language model) 41. The LLM 41 is a language model constructed by machine learning from large amounts of data. The LLM 41 outputs answers to questions input by users. The external server 40 further includes RAG (retrieval-augmented generation) 42. The RAG 42 includes data specific to each entity or real-time searched data, passing data that LLM has not learned to LLM to assist in answer generation performed by LLM. The RAG 42 may be configured as part of the information processing apparatus 10.

First, an outline of the present embodiment will be described, and details thereof will be described later. The method executed by the information processing apparatus registers a corresponding domain keyword and target phrase for each candidate search target and obtains a query that includes the domain keyword corresponding to the search target identified from an input question. The method executes multiple rounds of a search process including a step of inputting the query into a search engine, a step of identifying and counting each snippet containing the target phrase corresponding to the search target on a screen displaying search results, and a step of adding keywords contained in one or more identified snippets to the query. Furthermore, the method obtains an answer to the question based on the search results of a round in which a count of snippets containing the target phrase is the highest in the executed multiple rounds of the search process, and outputs the obtained answer.

Thus, according to the present embodiment, since the query is automatically modified and expanded to increase the number of snippets containing the target phrase on the screen of the search results using a search engine, it can reduce the user's burden while improving the accuracy of the answers to the questions compared to a method where multiple appropriate queries selected manually are registered in advance. Therefore, in terms of outputting accurate answers and reducing human costs, the technology for selecting appropriate queries is improved.

Next, configurations of the system 1 will be described in detail.

### (Configuration of Information Processing Apparatus)

As illustrated in FIG. 1, the information processing apparatus 10 includes a communication interface 11, a memory 12, and a controller 13.

The communication interface 11 includes one or more communication interfaces that connect to the domain DB 20 and the network 50, respectively. The communication interface is compliant with, for example, but not limited to, a mobile communication standard, a wired local area network (LAN) standard, or a wireless LAN standard, and may be compliant with any appropriate communication standard. In the present embodiment, the information processing apparatus 10 communicates with the domain DB 20, the terminal apparatus 30, and the external server 40 via the communication interface 11 and the network 50.

The memory 12 includes one or more memories. The memories included in the memory 12 may each function as, for example, a main memory, an auxiliary memory, or a cache memory. The memory 12 stores any information used for operations of the information processing apparatus 10. The memory 12 may store, for example, a system program, an application program, and the like. In the present embodiment, the memory 12 stores web browsers, application programs of any search engine, and queries input to the search engine, etc. The information stored in the memory 12 may be updated with, for example, information acquired from the network 50 via the communication interface 11.

The controller 13 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 13 controls the operations of the entire information processing apparatus 10.

### (Configuration of Domain DB)

The domain DB 20 is a database that stores information related to input and output to the search engine for each search target. The domain DB 20 stores, for example, the search target, domain keywords, and target phrases. Details of the data structure of the domain DB 20 will be described later.

### (Configuration of Terminal Apparatus 30)

As illustrated in FIG. 1, the terminal apparatus 30 includes a communication interface 31, a memory 32, a controller 33, an output interface 34, and an input interface 35. The configuration of the communication interface 31, the memory 32, and the controller 33 is fundamentally the same as that of the communication interface 11, the memory 12, and the controller 13 of the information processing apparatus 10, so the explanation will be simplified.

The communication interface 31 includes at least one interface for communication for connecting to the network 50.

The memory 32 includes one or more memories. In the present embodiment, the memory 32 stores application programs of the dialogue system provided by the operator using the information processing apparatus 10, and application programs of web browsers, etc.

The controller 33 includes at least one processor, at least one programmable circuit, at least one dedicated circuit, or a combination of these. The controller 33 is capable of executing the application programs stored in the memory 32.

The output interface 34 includes at least one output device for outputting information. The output device is a display for outputting information as video, a speaker for outputting information as audio, or the like, for example, but is not limited to these.

The input interface 35 includes one or more input devices that accept operations by the operator. The input device is a physical key, a capacitive key, a capacitive panel, a touch screen integrally provided with a display, a microphone for accepting audio input, or the like, for example, but is not limited to these.

### (Flow of Operations of Information Processing Apparatus)

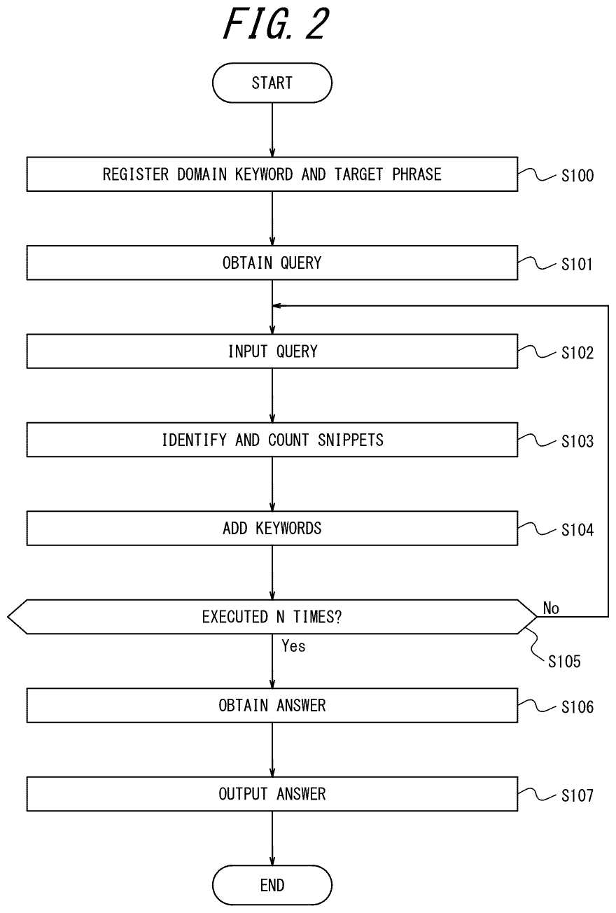

Operations of the information processing apparatus 10 according to the present embodiment will be described with reference to FIG. 2.

Step S100: The controller 13 registers the corresponding domain keywords and target phrases for each candidate of the search target. Specifically, the search target, domain keywords, and target phrases for each search target are input by the operator via the input interface 35 of the terminal apparatus 30, sent to the information processing apparatus 10 via the communication interface 31 by the controller 33, and stored in the domain DB 20 by the controller 13 of the information processing apparatus 10. Here, the data structure of the domain DB 20 will be explained with reference to Table 1. The search target is a part or main word (for example, “assessment amount”) in the question (for example, “Please tell me the assessment amount of used cars”) input by the operator. Domain keywords are one or more words (for example, one or more words such as “used”, “assessment”, and “amount”) that are input as a query to the search engine and are stored in association with the search target. The target phrase is one or more words (for example, a combination of words representing the assessment amount such as “yen”, “¥”, or a range of assessment amounts such as “¥* to ¥*”) that is the information to be obtained as a result of searching for the search target.

TABLE 1

| Search target | Domain keyword | Target phrase |
|---|---|---|
| Assessment | used assessment | [number string] million yen to |
| amount | amount | [number string] million yen |
| | | ¥[number string] to ¥[number |
| | | string] |
| | | ¥[number string] − ¥[number |
| | | string] |
| Residual | residual value | [number string]% |
| value rate | rate after years | [number string] percent |
| Actual fuel | actual fuel efficiency | [number string] km/L |
| efficiency | | [number string] km/liter |

Step S101: The controller 13 obtains a query containing domain keywords corresponding to the identified search target from the input question. Specifically, the controller 13 receives a question input via the input interface 35 of the terminal apparatus 30 by the operator (for example, “Please tell me the assessment amount for used cars”) from the terminal apparatus 30 via the communication interface 11, and identifies the search target (for example, “assessment amount”) from the received question. The controller 13 retrieves a query containing domain keywords (for example, “used assessment amount”) corresponding to the search target (for example, “assessment amount”) from the domain DB 20.

Step S102: The controller 13 inputs the query into the search engine as part of the search process. Specifically, The controller 13 inputs the query obtained in Step S101 (for example, “used assessment amount”) into the search engine. Here, the search engine may be any search engine such as Google® (Google is a registered trademark in Japan, other countries, or both).

Step S103: The controller 13 identifies and counts each snippet (hereinafter referred to as excellent snippets) containing the target phrase corresponding to the search target on the screen displaying the search results (hereinafter referred to as the results screen) as part of the search process. Specifically, the controller 13 acquires the results screen by step S102. The controller 13 retrieves the target phrase (for example, “Yen ¥”) corresponding to the search target (for example, “assessment amount”) from the domain DB 20. The controller 13 determines whether one or more snippets (for example, snippet A “Clearly visible from the used car market table! You can understand the market price of used cars with the combination of price, mileage, and year”, snippet B “The purchase assessment market as of YYYY/MM is ¥1,000,000 to ¥1,500,000”) contain the target phrase for each snippet, thereby identifying excellent snippets (For example, snippet A does not contain “Yen ¥” and therefore does not qualify as an excellent snippet. Snippet B qualifies as an excellent snippet because it contains “¥”.). The controller 13 further counts the number of excellent snippets (for example, snippet B). Here, a snippet is textual information that describes the content of a web page, displayed along with the link or title of the web page on the screen displaying the results of executing a search by inputting words or sentences into a search engine. In the present embodiment, the results screen may be the first page of the screen displaying the search results. Also, the number of snippets displayed on the results screen may be set freely.

Step S104: The controller 13 adds keywords (hereinafter referred to as excellent keywords) contained in one or more identified snippets to the query as part of the search process. Specifically, the controller 13 extracts excellent keywords (for example, “as of YYYY/MM”) from excellent snippets (for example, snippet B). The controller 13 adds the excellent keywords to the query. As a result, for example, the query becomes “Used assessment amount as of YYYY/MM”. The word “as of YYYY/MM” may be a specific value (for example, October 2024) or a wildcard for ambiguous searches (for example, *year*month). As an additional embodiment, excellent keywords may be either keywords that frequently appear in snippets containing the target phrase or keywords that appear only in snippets containing the target phrase, or both. Specifically, the controller 13 counts the keywords within the excellent snippets and determines the keywords to be added to the query based on the count (for example, in order from high-ranking keywords or randomly). As a further additional embodiment, the controller 13 may determine whether the excellent keywords are included in each snippet that does not contain the target phrase, and when it is determined that the excellent keywords are not included, may add the excellent keywords to the query.

Step S105: The controller 13 executes multiple rounds of the search process. Specifically, the controller 13 determines whether it has executed the steps from step S102 to step S104 as the search process N times. When the controller 13 determines that the search process has not been executed N times, it returns to step S102 (step S105—No) and repeats the search process. When the controller 13 determines that the search process has been executed N times, it proceeds to step S106 (step S105—Yes). Here, N is any integer value of 1 or more and may have a predetermined upper limit. As an additional embodiment, the controller 13 may terminate the execution of the search process when search results are obtained with a ratio of snippets containing the target phrase being above a threshold. For example, the controller 13 may count snippets on the results screen, and when the number of snippets is 10 and the number of good snippets in step S103 is 9, it may terminate the search process.

Step S106: The controller 13 obtains an answer to the question based on the search results of the round (hereinafter referred to as the best round) in which the count of snippets containing the target phrase is the highest in the executed multiple rounds of the search process. Specifically, the controller 13 determines the best round based on the number of good snippets counted in step S103 as a result of repeating the search process and obtains the results screen of the best round. The results screen may be stored in the memory 12 associated with the query in step S103 and retrieved from there, or it may be obtained by re-entering the query used in the best round into the search engine. The controller 13 sends the results screen of the best round along with the question input by the operator to the external server 40 in any data format. For example, the controller 13 may create an instruction sentence such as “Please refer to the provided information regarding the appraisal amount of used cars” and append the information from the results screen of the best round to the instruction sentence before sending it to the external server 40. The LLM 41 of the external server 40 refers to the received results screen of the best round as the RAG 42 and creates an answer to the question (for example, “The appraisal amount of the used car is ¥1,000,000 to ¥1,500,000”). The LLM 41 sends the created answer to the information processing apparatus 10. The controller 13 of the information processing apparatus 10 receives the answer from the external server 40.

Step S107: The controller 13 outputs the obtained answer. Specifically, the controller 13 sends the answer received from the external server 40 to the terminal apparatus 30 via the communication interface 11. The controller 33 of the terminal apparatus 30 outputs the answer to the operator via the output interface 34.

As an additional embodiment, the search process may delete some of the domain keywords and added keywords (hereinafter referred to as extended keywords) in the query. Specifically, the controller 13 generates a new query that includes the new extended keywords (“appraisal amount YYYY year MM month”) by deleting some of the extended keywords (for example, “used”) from the extended keywords in the query (for example, “used appraisal amount YYYY year MM month”). The addition to the query in step S104 and the deletion from the query in the present embodiment may be performed simultaneously or in any order. Furthermore, the controller 13 can freely generate combinations of extended keywords by combining additions and deletions to the query. The controller 13 may determine combinations of extended keywords based on the ranking of keywords using the history of past extended keywords, or randomly. Additionally, for example, combinations of multiple extended keywords may be determined using a genetic algorithm. Multiple child genes (such as “used assessment amount” and “market price in yen”) may be generated from multiple parent genes (such as “used assessment amount” and “market price in yen”). This allows for more appropriate query selection.

As an additional embodiment, the controller 13 updates the domain keywords with the query used in the round where the count of snippets containing the target phrase is the highest. Specifically, the controller 13 may overwrite the domain keywords in the domain DB 20 with the extended keywords in the query input to the search engine at the best round. For example, when “used assessment amount as of YYYY/MM” is the extended keyword in the query used at the best round, that extended keyword is overwritten in the domain keywords associated with the search target (“assessment amount”) in the domain DB 20. This allows for the immediate retrieval of appropriate queries from the domain DB 20.

As an additional embodiment, the query may be configured to further include the model name. At this time, the domain DB 20 may be structured for each model name. As a further additional embodiment, the search processing from step S102 to step S105 may be executed in parallel for each model name, adopting the query containing the extended keyword with the highest average occurrence rate of good snippets as the best round query across the search processing for each model name. This allows for efficient selection of appropriate queries.

As an additional embodiment, this disclosure (particularly, step S100) may be performed by any user. In other words, any user utilizing any dialogue system constructed by the system 1 can implement this disclosure. This method can be used more generally.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the information processing apparatus 10 in the above embodiment are distributed to multiple computers capable of communicating with each other can be implemented. For example, an embodiment in which some or all of the components of the information processing apparatus 10 are provided in the terminal apparatus 30 can also be implemented. The number of terminal apparatuses 30 included in the system 1 may be freely determined.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of the general purpose computer, and the program may be read and executed by a processor. Accordingly, the present disclosure can also be implemented as a program executable by a processor, or a non-transitory computer readable medium storing the program.

1. A method executed by an information processing apparatus, the method comprising:
registering a corresponding domain keyword and target phrase for each candidate search target;
obtaining a query containing the domain keyword corresponding to the search target identified from an input question;
executing multiple rounds of a search process including steps of:
inputting the query into a search engine;
identifying and counting each snippet containing the target phrase corresponding to the search target on a screen displaying search results; and
adding keywords contained in one or more identified snippets to the query;
obtaining an answer to the question based on the search results of a round in which a count of snippets containing the target phrase is highest in the executed multiple rounds of the search process; and
outputting the obtained answer.

2. The method according to claim 1, further comprising updating the domain keyword with the query used in the round in which the count of snippets containing the target phrase is highest.

3. The method according to claim 1, wherein the keywords added in the search process are either keywords that frequently appear in the snippets containing the target phrase, or keywords that appear only in the snippets containing the target phrase, or both.

4. The method according to claim 1, wherein the search process further includes a step of deleting one or some of the domain keyword and added keywords in the query from the query.

5. The method according to claim 1, further comprising ending execution of the search process at a point in time when a search result that an occurrence rate of the snippets containing the target phrase is equal to or greater than a threshold is obtained.
